(19) United States
(12) Patent Application Publication
(10) Pub. No.: US 2004/0039859 A1
(43) Pub. Date: Feb. 26, 2004

(54) Via configuration for differential signaling through power or ground planes

(75) Inventors: Jiangqi He, Chandler, AZ (US); Dong Zhong, Chandler, AZ (US); David G. Figueroa, Mesa, AZ (US); Yuan-Liang Li, Chandler, AZ (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/224,818

(22) Filed: Aug. 21, 2002

(51) Int. Cl. G06F 13/00

(52) U.S. Cl. 710/300

(57) ABSTRACT

A circuit board including a conductive plane, a first via and a second via. The first and second vias extend through the conductive plane such that there is no conductive material between the first and second vias within the conductive plane.

### TECHNICAL FIELD

Electronic devices with high-speed digital differential signaling, and in particular circuit boards with vias for communicating high-speed differential signals through power and/or ground planes in the circuit board.

### BACKGROUND

Digital differential signals are used for signal transmission on circuit boards, integrated circuit packages, interposer substrates and motherboards to help protect a signal from picking up external noise. Digital differential signals are also used in computer systems and communication systems.

A digital differential signal has two components that are 180 degrees out of phase with each other. Each component of the signal transitions between particular voltages that represent digital values of zero and one.

Digital differential signals are conventionally transmitted between layers in a circuit board using a pair of vias that are spaced closely together on a circuit board or substrate. Each via carries one of the components of the digital differential signal.

Semiconductor devices, computers, and other elements in digital systems continue to increase their operating data rate such that digital differential signals must be communicated at increasingly higher transition rates. The transition rate refers to the rate at which a digital signal transitions between states. Digital devices will soon require high-speed input/output (I/O) communications using digital differential signals that can exceed rates of 10 giga-transitions per second.

One problem with conventional circuit board via pairs is that conduction loss increases and signal integrity degrades as the transition rate increases. Conventional circuit board via pairs typically have an upper limit of less than 10 giga-transitions per second. Therefore, communicating digital differential signals above 10 giga-transitions per second with conventional via pairs results in unacceptably high conduction loss and reduced signal quality.

FIG. 1 illustrates a portion of a prior art circuit board 10 that communicates digital differential signals. Circuit board 10 includes a differential pair of closely spaced vias 12A, 12B that extend through a conductive power plane 14 and a conductive ground plane 15 with each of the vias 12A, 12B carrying a separate component of a digital differential signals.

The components of the signal are out of phase, such that the magnetic coupling between the vias 12A, 12B reduces the signal's susceptibility to external noise. However, as the signal passes through conductive plane 14, impedance is mismatched within the differential pair of vias 12A, 12B. Impedance mismatching within a differential pair can cause signal integrity problems. Impedance mismatching is exacerbated when signal lines are routed through numerous power and ground planes.

One technique that has been used to minimize conduction losses associated with high transition-rate digital differential signals is increasing via width. However, increasing the via width reduces signal routing ability and consumes more area on a circuit board, substrate or package. A larger via width also results in higher dielectric loss due to increased capacitance. The higher dielectric loss reduces signal integrity.

There is a need for a circuit board that includes vias which are suitable for communicating high-speed digital differential signals. The vias should be able to communicate high-speed digital differential signals with reduced conduction and dielectric losses and improved signal integrity.

### BRIEF DESCRIPTION OF THE DRAWINGS

A more complete understanding may be derived by referring to the detailed description and associated figures. It should be noted that like reference numbers refer to similar items throughout the figures.

FIG. 1 is a simplified perspective view illustrating a portion of a prior art circuit board.

FIG. 2 is a simplified perspective view similar to FIG. 1 illustrating a portion of a circuit board for communicating high-speed differential signals.

FIG. 3 is a block diagram of an electronic system incorporating at least one circuit board similar to the circuit board of FIG. 2.

### DETAILED DESCRIPTION

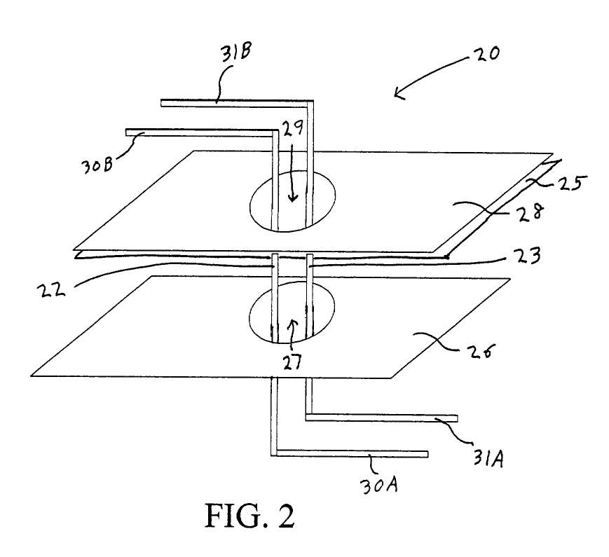

FIG. 2 illustrates a portion of a circuit board 20 having vias for communicating high-speed digital differential signals. Circuit board 20 includes a first via 22 and a second via 23 that extend through a conductive power plane 26 and a conductive ground plane 28 in parallel. There is no portion of power plane 26 in a space 27 between first via 22 and second via 23. In addition, there is no portion of ground plane 28 in a space 29 between first via 22 and second via 23.

Circuit board 20 is suitable for high-speed applications because there is no conductive material in spaces 27, 29 between vias 22, 23 to cause impedance mismatching as the signal components in vias 22, 23 travel through conductive planes 26, 28. In addition, the odd mode impedance in the via configuration is easily matched with trace impedances at the regular routing planes.

The lack of conductive material in spaces 27, 29 between vias 22, 23 also minimizes the ability of conductive planes 26, 28 to block the electromagnetic fields that are generated by the signal components in vias 22, 23. Since the electromagnetic fields in the vias 23, 23 are not significantly blocked by conductive planes 26, 28, the coupling between vias 22, 23 is enhanced. The strong coupling between vias 22, 23 results better in better signal quality. It should be noted that spaces 27, 29 between vias 22, 23 may include no material or an insulating material as long as spaces 27, 29 do not include any conductive material within conductive planes 26, 28.

During operation of circuit board 20, each of the vias 22, 23 carries a component of a digital differential signal. Via 22 carries one component of the signal between traces 30A, 30B, and via 23 carries the other component of the signal between traces 31A, 31B.

The width of vias 22, 23 may range from 10 and 40 microns, and spacings 27, 29 between vias 22, 23 may be ten microns or less, although the circuit boards and traces may have different dimensions and characteristics.

Vias 22, 23 may extend only through one of the conductive planes 26, 28. In addition, power plane 26 may be parallel to ground plane 28 with vias 22, 23 extending orthogonally through power and ground planes 26, 28. Various conductive materials may be used for vias 22, 23 and conductive planes 26, 28. These materials include gold, copper, aluminum and combinations thereof.

Power and ground planes 26, 28 in circuit board 20 may be separated by an insulating layer 25 having a dielectric constant between 3 and 4 and a thickness between 20 and 40 microns. Various insulating materials, such as Duroid, may form the insulating layer 25. Insulating layer 25 may also be formed from one or materials having different dielectric constants.

The via configurations may be suitable for carrying high-speed digital differential signals to and from a semiconductor die to provide for reduced conduction loss over conventional via pairs that are used to carry digital differential signals. The via configurations may also be suitable for carrying high-speed digital differential signals (i) on an interposer substrate which may be located between a packaged die and a circuit board; (ii) on circuit boards such as a motherboard of a computer; (iii) between a high-speed microprocessor and other elements on a motherboard; (iv) to various I/O elements of a computer system.

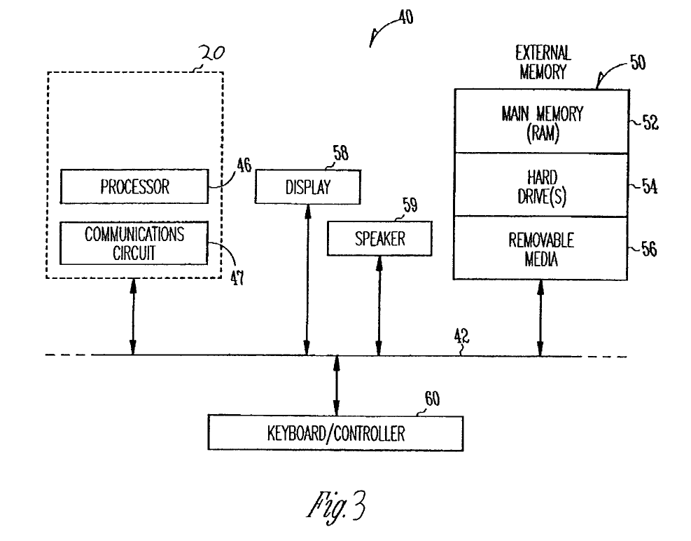

FIG. 3 is a block diagram of an electronic system 40 incorporating at least one electronic assembly, such as circuit board 20 illustrated in FIG. 2. Electronic system 40 may be a computer system that includes a system bus 42 to electrically couple the various components of electronic system 40 together. System bus 42 may be a single bus or any combination of busses.

Circuit board 20 is electrically coupled to system bus 42 and may include any circuit, or combination of circuits. In one embodiment, circuit board 20 includes a processor 46, which can be of any type. As used herein, processor means any type of circuit such as, but not limited to, a microprocessor, a microcontroller, a graphics processor or a digital signal processor. Other types of circuits that can be included in circuit board 20 are a custom circuit or an application-specific integrated circuit, such as communications circuit 47 for use in wireless devices such as cellular telephones, pagers, portable computers, two-way radios, and similar electronic systems.

The electronic system 40 may also include an external memory 50 that in turn may include one or more memory elements suitable to the particular application, such as a main memory 52 in the form of random access memory (RAM), one or more hard drives 54, and/or one or more drives that handle removable media 56, such as diskettes, compact disks (CDs) and digital video disks (DVDs).

The electronic system 40 may also include a display device 58, a speaker 59, and a controller 60, such as a keyboard, mouse, trackball, game controller, microphone, voice-recognition device, or any other device that inputs information into the electronic system 40.

As shown herein, circuit board 20 can be implemented in a number of different embodiments, including an electronic package, an electronic system and a computer system. The elements, materials, geometries and dimensions can all be varied to suit particular requirements.

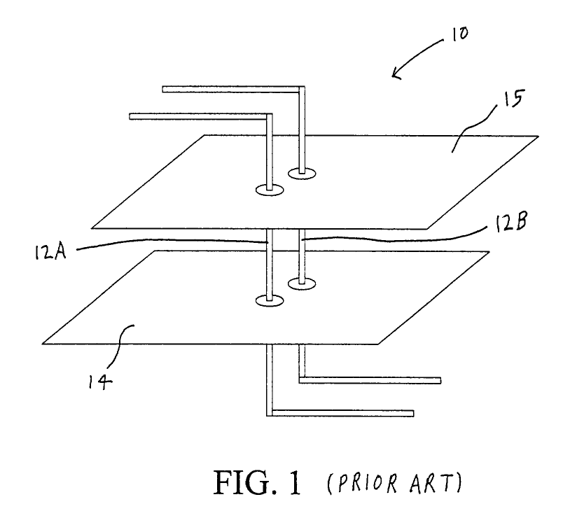

FIGS. 1-3 are merely representational and are not drawn to scale. Certain proportions thereof may be exaggerated while others may be minimized.

Circuit boards having vias suitable for communication of high-speed digital differential signals have been described. The vias communicate high-speed digital differential signals with reduced conduction loss and improved signal integrity.

Many other embodiments will be apparent to those of skill in the art from the above description. Modifications, equivalents and variations are within the scope of the appended claims.

What is claimed:

1. A circuit board comprising:
a first conductive plane;
a first via extending through the first conductive plane; and
a second via extending through the first conductive plane, wherein there is no conductive material between the first and second vias within the first conductive plane.

2. The circuit board of claim 1 wherein each via carries a component of a digital differential signal.

3. The circuit board of claim 2 wherein the digital differential signal has a transition rate of at least 10 giga transitions per second.

4. The circuit board of claim 1 wherein there is an insulating material between the first and second vias in the first conductive plane.

5. The circuit board of claim 1 wherein there is no material between the first and second vias in the first conductive plane.

6. The circuit board of claim 1 further comprising traces electrically coupled to the first via and the second via.

7. The circuit board of claim 1 wherein the first and second vias are copper.

8. The circuit board of claim 1 further comprising a second conductive plane, the first and second vias extending through the second conductive plane such that there is no conductive material between the first and second vias in the second conductive plane.

9. The circuit board of claim 8 further comprising an insulating layer between the first and second conductive planes.

10. The circuit board of claim 8 wherein the first and second conductive planes are copper.

11. The circuit board of claim 8 wherein the first and second conductive planes are substantially parallel.

12. The circuit board of claim 11 wherein the first and second vias are substantially parallel as the first and second vias extend through the first and second conductive planes.

13. The circuit board of claim 12 wherein the first and second vias extend orthogonally through the first and second conductive planes.

14. The circuit board of claim 8 wherein the first conductive plane is a power plane and the second conductive plane is a ground plane.

15. A computer system comprising:
a bus;
a memory coupled to the bus; and
a circuit board electrically coupled to the bus, the circuit board including a first conductive plane and first and second vias extending through the first conductive plane with no conductive material between the first and second vias within the first conductive plane.

16. The computer system of claim 15 further comprising a second conductive plane, the first and second vias extending through the second conductive plane with no conductive material between the first and second vias within the second conductive plane.

17. The computer system of claim 16 wherein the first conductive plane is a power plane and the second conductive plane is a ground plane.

18. A circuit board comprising:
a power plane;
a ground plane;
a first via extending through the power and ground planes;
a second via extending through the power and ground planes, wherein there is no conductive material between the first and second vias within the power plane and the ground plane, the first and second vias being substantially parallel to one another as the first and second vias extend orthogonally through the power and ground planes; and
traces electrically coupled to the first via and the second via.

19. The circuit board of claim 18 wherein each via carries a component of a digital differential signal.

20. The circuit board of claim 19 further comprising an insulating layer between the power plane and the ground plane.
